(19) United States
(12) Patent Application Publication
(10) Pub. No.: US 2023/0095491 A1
(43) Pub. Date: Mar. 30, 2023

(54) High-Pressure Compressor and System with a High-Pressure Compressor

(71) Applicant: Kyros Hydrogen Solutions GmbH, Föritztal (DE)

(72) Inventors: Joachim Löffler, Föritztal (DE); Matthias Böhm, Föritztal (DE)

(21) Appl. No.: 17/948,735

(22) Filed: Sep. 20, 2022

(30) Foreign Application Priority Data
Sep. 28, 2021 (DE) 10 2021 125 047.1

(51) Int. Cl. F04B 45/04; F04B 27/10

(52) U.S. Cl. CPC F04B 45/04; F04B 27/1081; F05D 2220/3219

(57) ABSTRACT

A high-pressure compressor and a system with a high-pressure compressor are described. I one example, the high-pressure compressor has a housing that surrounds at least one compressor chamber and a media chamber, wherein the compressor chamber and the media chamber are separated from one another in the housing via a diaphragm. The housing has at least one first connection, which opens into the media chamber and via which a medium can be introduced into and/or discharged from the media chamber. The housing has at least one second connection, which opens into the compressor chamber and via which a gas or gas mixture can be introduced and/or discharged. The diaphragm comprises a polymer -based material and is deformable to compress a gas or gas mixture that can be introduced into the compressor chamber by introducing a medium into the media chamber.

### PRIORITY CLAIM

The present application is based on and claims priority to German Application DE102021125047.1, entitled “High-pressure compressor and system with a high-pressure compressor,” having a filing date of Sep. 28, 2021 which is incorporated by reference herein.

### FIELD

The present disclosure relates to a high-pressure compressor and a system with a high-pressure compressor which are designed for the compression of a gas or gas mixture.

### BACKGROUND

Gases and gas mixtures with high pressures are required for various applications. In some cases, the pressures are in the range of several hundred bar or even over 1000 bar. For example, gases or gas mixtures with several 100 bar are required for applications in the field of energy-generating facilities or for mobile applications (e.g. vehicles). Hydrogen (H₂), for example, is usually stored in appropriate containers (gas cylinders) at a pressure of about 300 bar for intermediate storage. Difficulties arise in compressing the gases or gas mixtures, with conventional solutions having disadvantages.

### SUMMARY

One example aspect of the present disclosure is directed to a high-pressure compressor for compressing a gas or gas mixture, The high-pressure compressor includes a housing which surrounds at least one first compressor chamber and a media chamber. The at least one first compressor chamber and the media chamber in the housing are separated from one another by at least one first diaphragm. The housing includes at least one first connection which opens into the media chamber and via which a medium can be introduced into or discharged from the media chamber. The housing includes at least one second connection which opens into the at least one first compressor chamber and via which a gas or gas mixture can be introduced or discharged. The at least one first diaphragm includes a polymer-based material and is deformable for compressing the gas or gas mixture that can be introduced into the at least one first compressor chamber by introducing a medium into the media chamber.

### BRIEF DESCRIPTION OF THE FIGURES

In the figures shows:

FIG. 1 depicts an exploded view of a high-pressure compressor of a first embodiment;

FIG. 2 depicts different views of a first and second compressor head of the high-pressure compressor of FIG. 1;

FIG. 3 depicts a schematic representation of a compressor system with a high-pressure compressor according to FIG. 1;

FIGS. 4-7 depict different steps of high-pressure compression in the compressor system according to FIG. 3;

FIG. 8 depicts an exploded view of a high-pressure compressor of a second embodiment;

FIG. 9 depicts various views of an intermediate plate of the high-pressure compressor of FIG. 8;

FIG. 10 depicts a schematic representation of a compressor system with a high-pressure compressor according to FIG. 8;

FIGS. 11-14 depict different steps of high-pressure compression in the compressor system according to FIG. 10;

FIG. 15 depicts schematic representations of example embodiments of a first and/or a second diaphragm for a high-pressure compressor; and

FIG. 16 depicts a schematic diagram of high-pressure compression in a compressor system.

### DETAILED DESCRIPTION

According to the general technical understanding, “high pressure” refers to the high-pressure compression of gases and gas mixtures at a compression of 40 bar or more above atmospheric pressure.

The high-pressure compressor and system described herein can be used for high-pressure compression of combustible or oxidizing gases or gas mixtures. An example of a combustible gas is hydrogen. An example of oxidizing gas is oxygen. Combustible or oxidizing gas mixtures may contain hydrogen and oxygen.

Known compressors for gas and gas mixtures are designed, for example, as piston compressors and have a linearly movable piston head which compresses a gas or gas mixture introduced into a receiving chamber by reducing the size of the receiving chamber and thus compresses it. The compressed gas or gas mixture is then discharged and fed to an appliance.

Such piston compressors are disadvantageous in particular because, due to the moving piston head, a seal must be provided to seal the piston head against a wall bounding the receiving chamber. However, this seal cannot provide a complete sealing on the one hand because there is permanent movement between the components to be sealed, and is subject to enormous wear due to the frequent movement.

Furthermore, such a compressor requires a lot of installation space - depending on the compression ratio.

In contrast, the problem is to provide a solution for the high-pressure compression of gases and gas mixtures that both eliminates the disadvantages of the prior art and provides an alternative to the prior art that is simple in design and permits a high compression of gases and gas mixtures with a small installation space. The aim is to provide a solution for high-pressure compression that has no moving components that are primarily used for compression and are in contact with the environment.

The above-mentioned problem is solved according to examples of the present disclosure by a high-pressure compressor for compressing a gas or gas mixture, having a housing which surrounds at least one first compressor space and a media chamber, wherein the at least one first compressor space and the media chamber in the housing are separated from one another via at least one first diaphragm, wherein the housing has at least one first connection which opens into the media chamber and via which a medium can be introduced into and/or discharged from the media chamber, wherein the housing has at least one second connection which opens into the at least one first compressor chamber and via which a gas or gas mixture can be introduced and/or discharged, wherein the at least one first diaphragm consists of a polymer-based material and is deformable for compressing the gas or gas mixture which can be introduced into the at least one first compressor chamber by introducing a medium into the media chamber.

The high-pressure compressor is designed as a diaphragm compressor and thus compresses the gas or gas mixture that can be introduced into the media chamber by deforming the at least one first diaphragm. Advantageously, compared to piston compressors, such a diaphragm compressor does not have a seal that is in contact with moving components, so that no sealing problems arise. For example, the at least one first diaphragm may be sealed in the housing, and multiple sealing means may be provided. For example, the at least one first diaphragm may be braced between two plates, with the at least one first diaphragm made of polymer-based material disposed between the plates of the housing, which itself serves as a “sealing ring” due to its material properties.

The high-pressure compressor is configured such that the at least one first diaphragm is in contact with the inner wall of the at least one first compressor chamber in a first position. Thus, the space available for introducing the gas or gas mixture includes both the media chamber and the at least one first compressor chamber. The entire volume of the high-pressure compressor is thus available for compression.

After a gas or gas mixture is introduced via the at least one second connection, the supply is interrupted and the line is shut off. Compression then takes place, with an incompressible medium (e.g. water, (hydraulic) oil, etc.) being introduced into the media chamber via the at least one first port. The pressure exerted on the at least one first diaphragm via the medium corresponds to the pressure on the side of the gas or gas mixture, so that a substantially differential pressureless compression is performed within the housing of the high-pressure compressor. This means that the pressure acting on the at least one first diaphragm within the housing is equal on both sides.

Upon compression of the gas or gas mixture that has been introduced into the at least one first compressor chamber, the pressure on the at least one first diaphragm from the side of the media chamber is increased by the incompressible medium, causing deformation of the at least one first diaphragm in the direction of the at least one first compressor chamber, which then results in compression of the gas or gas mixture received in the at least one first compressor chamber.

The at least one first diaphragm can be deformed via the incompressible medium until the at least one first diaphragm is completely or almost completely in contact with an inner wall of the at least one first compressor chamber. Thus, a high compression is achieved because the gas or gas mixture can be compressed by substantially the entire volume of the at least one first compressor chamber. Compared to known devices, a higher compression is thus achieved.

The deformation of the at least one first diaphragm may be achieved by stretching the diaphragm, for which purpose the diaphragm is appropriately designed in terms of its structure and/or internal structure to achieve the required deformation.

Further advantageous embodiments result from further developments defined by the subclaims.

In this regard, in further embodiments, the compressor chamber and the media chamber may have substantially equal volumes.

In further embodiments, the at least one first compressor chamber and/or the media chamber may have a substantially spherical segment shape and the at least one first diaphragm may form the base surface of the spherical segment. In this case, the corresponding inner walls of the at least one first compressor chamber and the media chamber are substantially concave and thus have a curved inner surface. The at least one first diaphragm can then, for example, bear against the curved inner walls, wherein after the at least one first diaphragm has been completely deformed, it is in flat contact with the corresponding inner wall of the at least one first compressor chamber. The compressed gas or gas mixture can then be forced into at least one channel in the housing, which is in communication with the second connection.

In still further embodiments, the substantially concave shaped inner wall of the at least one first compressor chamber may have grooves or the like extending towards the center, the depth and width of which grooves or the like may increase and decrease, respectively, in order to may decrease, respectively, so that during stepwise compression by deformation of the at least one first diaphragm the compressed gas or gas mixture is pressed into the grooves or the like and is discharged therefrom after complete deformation of the at least one first diaphragm, thereby taking into account the fact that the at least one first diaphragm in the completely deformed state abuts the inner wall of the at least one first compressor chamber.

The at least one first diaphragm may be deformable to the extent that it comes into contact with the inner wall of the at least one first compressor chamber and/or the media chamber from an initial position.

In further embodiments, the high-pressure compressor may include a second compressor chamber separated from the media chamber by a second diaphragm, wherein the media chamber is disposed between the first compressor chamber and the second compressor chamber, and wherein the housing includes at least one fourth connection that opens into the second compressor chamber and through which a gas or gas mixture may be introduced and/or discharged. In such embodiments, the two diaphragms are simultaneously deformed in different directions for compressing a gas or gas mixture introduced into the first compressor chamber and the second compressor chamber. For this purpose, an incompressible medium is fed into the media chamber.

The second diaphragm can be designed analogously to the embodiments described above. In the various designs, the diaphragms and the associated first and second compressor chambers can each be designed and constructed in the same way.

In further embodiments, the housing of the high-pressure compressor may have a layered structure and comprise at least - a first compressor head with the first compressor chamber and a second compressor head with the media chamber, wherein the first diaphragm is arranged between the first compressor head and the second compressor head, or - have a first compressor head with the first compressor chamber, an intermediate plate with the media chamber, and a third compressor head with the second compressor chamber, the first diaphragm being arranged between the first compressor head and the intermediate plate and the second diaphragm being arranged between the intermediate plate and the third compressor head.

The layered design provides a simple structure of the high-pressure compressor. In addition, the assembly of the high-pressure compressor can be carried out easily. For example, the individual layers can be fastened to each other by screws or the like, with the screws or the like being guided through holes in the respective layers. Furthermore, the layered structure offers the possibility of bracing the diaphragms between the individual layers and making the interior of the housing absolutely gas-tight.

In further embodiments, the at least one first diaphragm and/or the second diaphragm may have a greater areal extent than a maximum diameter of the at least one first compressor chamber, the media chamber, and/or the second compressor chamber. Thus, the at least one first diaphragm can be arranged between individual layers of the housing and also provides a seal. Thus, separate sealing means can be dispensed with.

In further embodiments, the at least one first diaphragm may comprise an elastomer. Whereby the elastomer may be an ethylene propylene diene monomer or fluorocarbon rubber. Such materials are particularly suitable for the high-pressure compressor in use with flammable gases and gas mixtures, as they have sufficient properties to both prevent diffusion of gas or gas mixture and not be damaged or destroyed by the gas or gas mixture.

In general, the deformability of the at least one first diaphragm results in the advantage that a greater deflection can be achieved compared to simple, disk-like diaphragms. Thus, a significantly increased compression of a gas or gas mixture can be achieved with a small installation space, in particular compared to disk-like, non-deformable diaphragms. The greater deflection of the at least one first diaphragm also allows to reduce the frequency of the at least one first diaphragm, i.e. the movements of the at least one first diaphragm in the corresponding directions for compression, whereby the performance in relation to the provided amount of compressed gas or gas mixture is at least as great as with a comparable, non-deformable diaphragm. Lower frequencies have a particularly positive effect on the service life of the at least one first diaphragm and thus of the high-pressure compressor. The deformability of the at least one first diaphragm can be supported, for example, by a structured design of the at least one first diaphragm, wherein the diaphragm has changes in its composition or constructive design features (e.g. grooves and beads - “loudspeakers”).

The above problem is also solved by a compressor system for high-pressure compression of a gas or gas mixture, comprising at least one high-pressure compressor according to one of the embodiments given above, a gas or gas mixture supply, a gas or gas mixture storage, a media supply and conveying means for conveying a gas or gas mixture as well as an incompressible medium, and control means for regulating the flow of the gas or gas mixture and the incompressible medium via associated lines, wherein - the high-pressure compressor comprises a housing surrounding at least one first compressor chamber and a media chamber, wherein the at least one first compressor chamber and the media chamber are separated from each other in the housing via at least one first diaphragm, - the high-pressure compressor comprises at least one first connection opening into a media chamber, - the first connection is connected to the media supply via associated lines and corresponding conveying and/or control means, so that an incompressible medium can be introduced from the media supply via the first connection into the media chamber and from the media chamber into the media supply - the high-pressure compressor has at least one second connection opening into the compressor chamber, - the at least one second connection is connected to the gas or gas mixture supply and the gas or gas mixture storage via associated lines and corresponding conveying and/or control means, so that a gas or gas mixture can be introduced from the gas or gas mixture supply into the first compressor chamber and from the first compressor chamber into the gas or gas mixture storage, and - the incompressible medium can be pressurized via associated conveying and/or control means, so that a deformation of the at least one first diaphragm and, via this, a compression of the gas or gas mixture received in the at least one first compressor chamber can be achieved, for which purpose lines to and from the gas or gas mixture supply, the gas or gas mixture storage and the media supply can be closed off via corresponding control means.

The system offers the possibility of high-pressure compression of a gas or gas mixture with at least one high-pressure compressor which, due to the large deflection of the at least one first diaphragm, requires fewer load cycles to compress the same amount of gas compared to a conventional compressor, wherein for this purpose the delivery and control means also have reduced delivery and control cycles. This makes it easier to design the system. The control of the system can also be simplified.

In an advantageous embodiment of the compressor system, the pressurization of the medium within the at least one medium chamber can be carried out via the conveying means, which convey the incompressible medium into the at least one medium chamber. The conveying means are designed, for example, as a piston and/or as a pump. It is particularly advantageous, if a conveying means is designed as a pump, that the piston can be completely omitted. In such an advantageous embodiment, a system without a piston can be used as a conveying and/or pressurizing means.

In a further advantageous embodiment, the media circuit and the medium guided and conveyed thereover can be heated and/or climatized at least in the region of the at least one first connection. Advantageously, a viscosity of the incompressible medium is thus achieved in order not to generate counterpressure on the conveying means when flowing into the at least one media chamber via the at least one first connection.

Further advantages, features and design possibilities result from the following figure description of non-restrictive embodiment examples.

In the drawings, elements provided with the same reference signs essentially correspond to each other, unless otherwise indicated. Furthermore, components are not shown and described which are not essential for understanding the technical teachings disclosed herein. Furthermore, the reference signs are not repeated for all elements already introduced and shown, provided that the elements themselves and their function have already been described or are known to a person skilled in the art.

The figures show embodiments of a high-pressure compressor 100, compressor systems 500, and methods for high pressure compression in a compressor system 500, which are described below by way of example, being possible embodiments of the technical teachings disclosed herein. Thus, the embodiments shown and described below are not limiting and may have additional features disclosed herein or alternatives disclosed. Also, features of the individual embodiments may also be provided reciprocally, even if described for only one of the embodiments, provided that they are also suitable therefor.

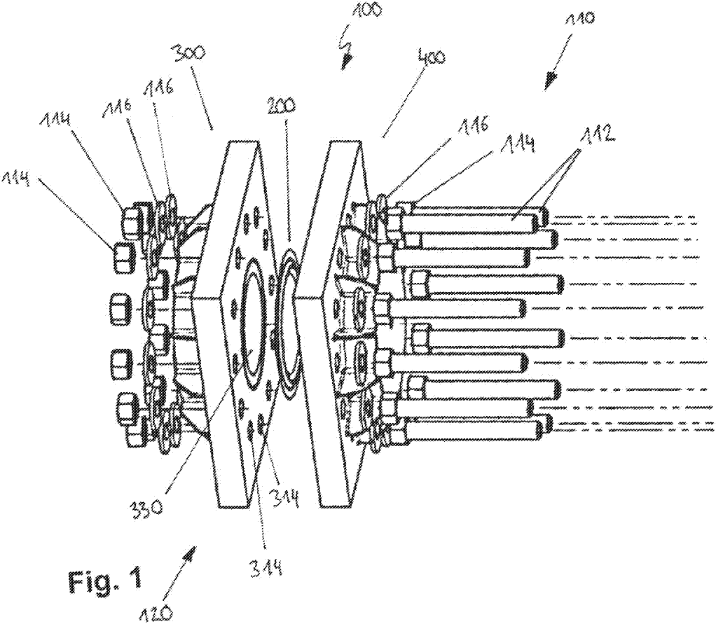

FIG. 1 shows an exploded view of a high-pressure compressor 100. The high-pressure compressor 100 can be used, for example, to compress a gas, such as hydrogen (H₂), or a gas mixture. In this case, a high pressure compression of the gas takes place. In this context, high-pressure compression is used for pressures from about 40 bar.

Conventional high-pressure compressors have a piston head mounted in a displaceable manner in order to be able to generate the high pressures. The piston head is moved a relatively long distance within a cylindrical tube in order to achieve the high compression of the gas.

The high-pressure compressor 100 described herein has the advantage over known high-pressure compressors in that the device is relatively small in size and, in addition, no moving components are provided that communicate with the environment and primarily effect high pressure compression. Therefore, a gas-tight design is ensured. In addition, there is no abrasion and thus no destruction of sealants as in the prior art because no seals are required and the diaphragm 200 itself serves as a sealing. The component provided for compressing a gas, in the form of a first diaphragm 200 made of a polymer-based material, is arranged within a housing 120 of the high-pressure compressor 100 and is therefore not in contact with the environment.

The high-pressure compressor 100 of FIG. 1 has a housing 120 having a first compressor head 300 and a second compressor head 400. In the embodiment shown, the compressor heads 300 and 400 are identically configured so that descriptions of one of the compressor heads 300, 400 also apply to the other compressor head 300, 400, respectively. In further embodiments not shown, however, the compressor heads 300, 400 may also have differences from one another, in particular in the design and arrangement of connections, etc.

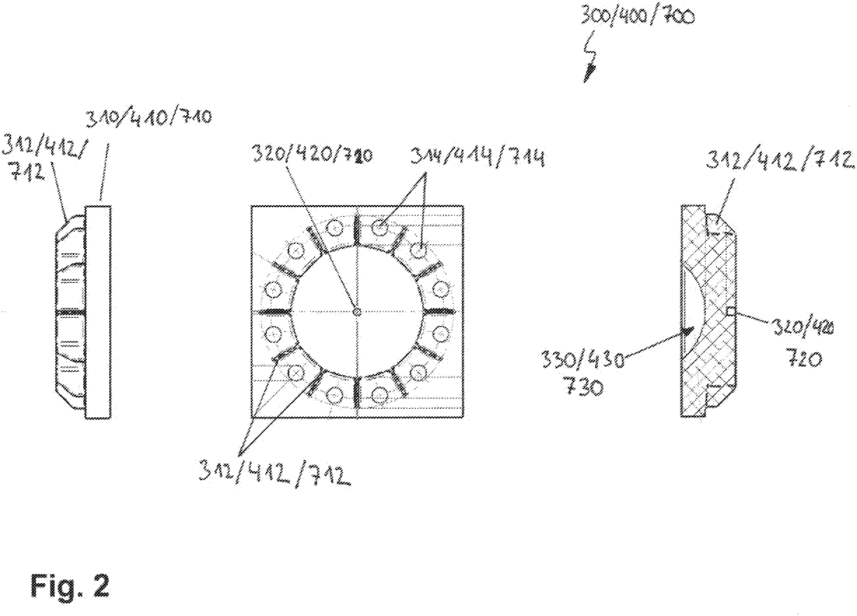

The compressor heads 300, 400 are made of metal or a metal alloy and each have a solid plate 310, 410. The design of the compressor heads 300, 400 is shown in FIG. 2.

The material used for the compressor heads 300, 400 may be, for example, a stainless steel or a stainless steel alloy, such as a stainless steel alloy of the 316 L group.

The compressor heads 300, 400 each have a compressor chamber 330 or a media chamber 430 on opposite sides when assembled. Here, the compressor chamber 330 serves to receive a gas or gas mixture that is compressed. The media chamber 430 is used to hold a medium that is required to deform the diaphragm 200 to compress the gas or gas mixture.

Here, the compressor chamber 330 and the media chamber 430 primarily serve to introduce the gas/gas mixture or the medium into the chambers. During high pressure compression, the diaphragm 200 is displaced in such a way that it comes into contact with the opposing inner walls of the compressor chamber 330 and the media chamber 430. Thus, a gas/gas mixture or a medium can also be received in the space spanned by the compressor chamber 330 or the media chamber 430 inside the compressor heads 300, 400 by a corresponding deformation of the diaphragm 200.

In the embodiment shown, the compressor chamber 330 and the media chamber 430 are concave. During high pressure compression, the elastically deformable diaphragm 200 can be deformed to such an extent that the diaphragm 200 comes into contact with the inner walls of the compressor chamber 330 and the media chamber 430 over substantially the entire surface.

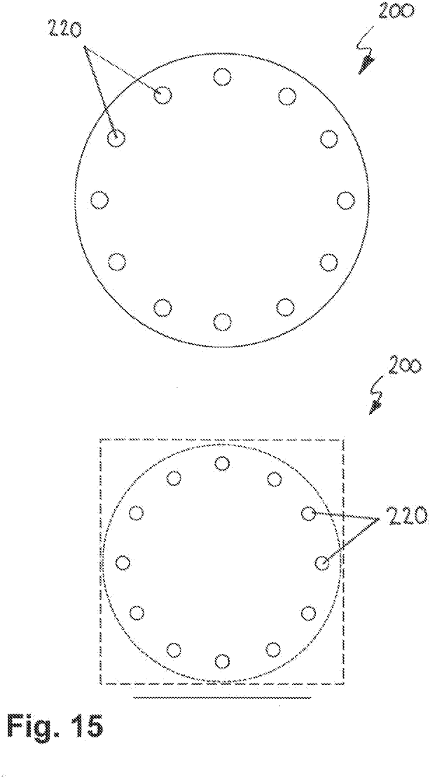

The diaphragm 200, which is made of a polymer-based material, is arranged between the compressor heads 300, 400. Elastomers are particularly suitable materials. Possible designs of such diaphragms 200 are shown in FIG. 15.

During high pressure compression, the diaphragm 200 is deformed so that it gradually comes into contact with the inner walls of the compressor chamber 330 or media chamber 430.

Therefore, the design of the diaphragm 200 allows the entire volume within the housing 120 of the high-pressure compressor 100, comprising the compressor chamber 330 and the media chamber 430, to be used for compressing a gas/gas mixture.

Thus, depending on the design of the high-pressure compressor 100 and its components, an adjustment of the compression ratio of gases or gas mixtures can be achieved. In particular, the deformability of the diaphragm 200 is decisive for the compression. The greater the deformability, the greater the compression. The diaphragm 200 can assume a neutral position (FIG. 15) and be deformed in both directions from the neutral position.

To deform the diaphragm 200 for high pressure compression of a gas/gas mixture introduced via the compressor chamber 330, an incompressible medium is introduced under pressure via the media chamber 430. This ensures that the pressure via the medium on the diaphragm 200 exerts a correspondingly high pressure on the gas/gas mixture, which is then compressed or densified. For example, water or a (hydraulic) oil can be used as the incompressible medium.

Both the compressor chamber 330 and the media chamber 430 each have at least one connection 320, 420 through which the gas/gas mixture or the medium is supplied and discharged. In further embodiments, separate connections may be provided for supplying and discharging the gas/gas mixture or the media.

The supply or discharge takes place centrally in the central area of the compressor chamber 330 or the media chamber 430. In particular, the second connection 320 for the supply of gas/a gas mixture can be designed in such a way that, starting from a central supply opening in the second connection 320 on the outside of the compressor head 300, the connection 320 merges into a plurality of smaller channels which have a small diameter compared to the inlet diameter. These channels then protrude into the compressor chamber 330 via corresponding openings, thus preventing punctual, central loading of the diaphragm 200 as the gas/gas mixture or medium flows in/out. By dividing the central inlet into many smaller channels, the load is spread out. These openings in the compressor chamber 330 and media chamber 430 may extend over an area equal to, for example, three times the diameter of the connection 320, 420. Preferably, the openings of these channels may open only into the area which has the greatest depth relative to the volume of the compressor chamber 330 or media chamber 430.

The supply and discharge of the gas/gas mixture and the medium are controlled by appropriate valves.

The diaphragm 200 itself is arranged between the opposing planar surfaces of the cylinder heads 300, 400 and the plates 310, 410, respectively. The diaphragm 200 has a planar extension that is greater than the planar extension of the compressor chamber 330 and the media chamber 430. Thus, in the installed state, the diaphragm 200 is in contact with the plates 310, 410.

Via fastening means 110, the two cylinder heads 300, 400 and the diaphragm 200 arranged therebetween are connected to each other. The plates 310, 410 and the first diaphragm 200 have through openings 314, 414, 220 through which threaded rods 112 are passed. Via nuts 114 and washers 116, the cylinder heads 300, 400 and the diaphragm 200 can be connected to each other and the diaphragm 200 can be braced. This provides a sealing between the compressor chamber 330 and the media chamber 430 from the environment. Due to the material of the first diaphragm 200, additional sealing is achieved in the area of the contact surfaces between the compressor heads 300, 400 and the first diaphragm 200. Furthermore, structures may also be provided in the contact surfaces of the compressor heads 300, 400 which partially deform the diaphragm 200 in the connected state in order to further improve the gas-tight design of the high-pressure compressor 100 via this.

FIG. 2 shows various views of a first and second compressor head of the high-pressure compressor of FIG. 1. Walls 312, 412 are located between the openings 314, 414. The design of the compressor heads 300, 400 is such that they have a sufficiently large wall thickness around the compressor chamber 330 and the media chamber 430.

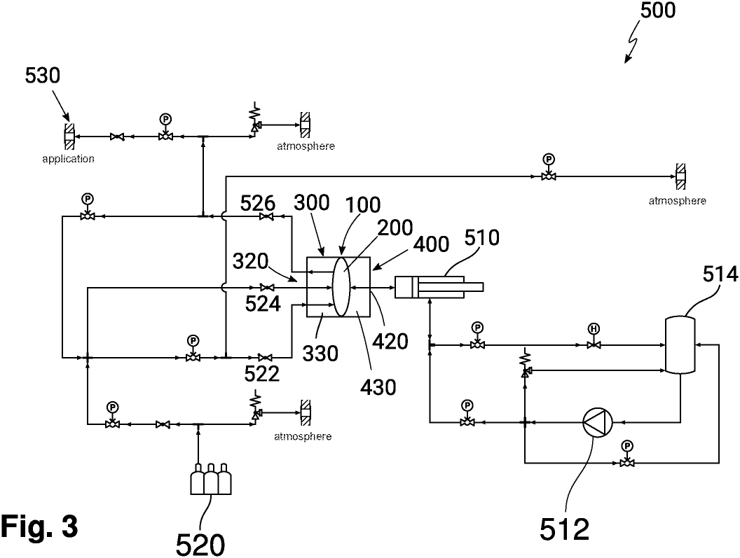

FIG. 3 shows a schematic representation of a compressor system 500 comprising a high-pressure compressor 100 according to the embodiment of FIG. 1.

In further embodiments not shown, a compressor system 500 may also be operated with a variation of the high-pressure compressor 100 shown in FIG. 1, which falls within the technical teachings described herein. Finally, a compressor system 500 may in principle include a plurality of high pressure compressors 100 connected, for example, in parallel or in series.

In addition to the high-pressure compressor 100, the compressor system 500 comprises piping and control means and valves and a piston 510 and a tank 514 in which an incompressible medium is received. The tank 514, the piston 510, and a pump 512 are part of a media circuit, which again is part of the compressor system 500.

The compressor system 500 comprises a gas or gas mixture circuit that, in addition to lines for supplying and discharging the gas or gas mixture, has control devices, valves, a supply 520 in which the gas or gas mixture for high pressure compression is stored, and a connection to any application 530.

The compressor system 500 further includes relief valves that allow gas to escape to atmosphere when critical, adjustable pressures in the system are exceeded. In the shown embodiment of the compressor system 500, a compression of a gas or gas mixture from a pressure of at least 10 bar in the supply 520 to a maximum of 1000 bar is performed, so that a gas or gas mixture with a pressure of a maximum of 1000 bar is provided to the application 530.

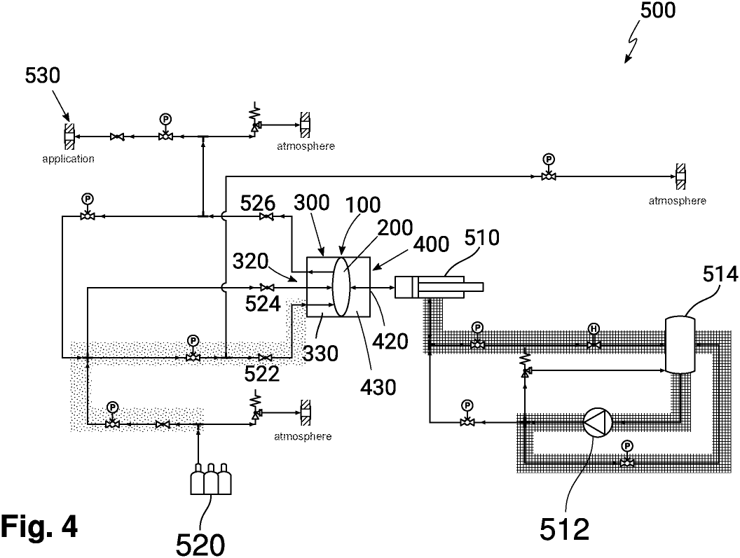

The compression sequence in the compressor system 500 via the high-pressure compressor 100 is shown in FIGS. 4-7 and is described below with reference to FIGS. 4--7.

### Filling the High-Pressure Compressor 100 (Fig. 4)

The gas side or compressor chamber 330 of the compressor head 300 is filled with gas from the supply 520. For this purpose, the valve from the supply 520 and a valve 522 are opened, so that gas is supplied to the compressor chamber 330 via the second connection 320. Gas is stored in the supply 520 at a pressure of about 10 bar. The diaphragm 200 is deflected in the direction of the water side, i.e. in the direction of the media chamber 430, and the pump 512 in the media circuit pumps the medium (water) for this step back into the tank 514, which serves as a reservoir for the water.

A relief line of the media circuit from the cylinder of the piston 510 is opened and due to the higher pressure on the gas side (compressor room side), the diaphragm 200 is fully contacted with the inner wall of the media chamber 430 of the compressor head 400 as well as the head of the piston 510 is moved to its initial position.

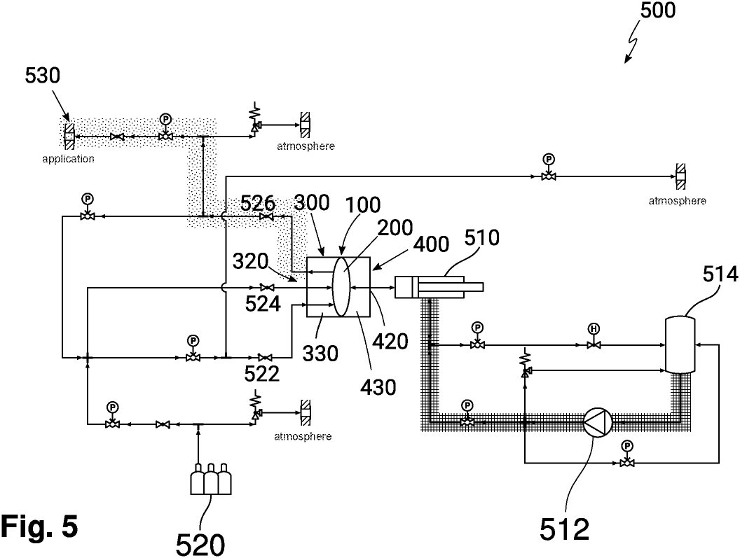

### Stroke Into the Application (Fig. 5)

The inlet valve 522 of the gas side is closed and the valve 526 to the application 530 is opened. In parallel, in the media circuit, the circuit back to tank 514 and the relief line are closed and water is forced into the back side of the cylinder of piston 510, causing more volume to be delivered into compressor head 400 via the water side of high-pressure compressor 100. This change in volume provides compression of the gas on the gas side, resulting in an increase in pressure in the application 530.

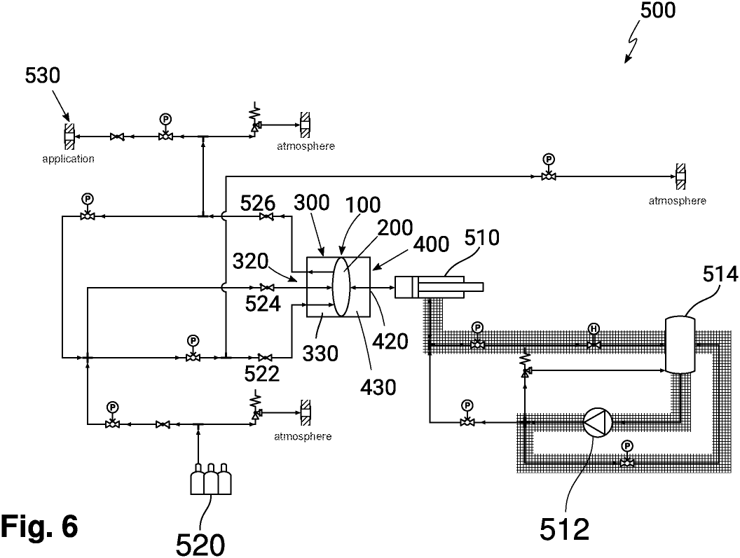

### Depressurizing the High-Pressure Compressor 100 (Fig. 6)

The valve 526 to the gas application 530 is closed. The water circuit in the media circuit back into tank 514 is opened and, in parallel, the relief line into tank 514. Due to the applied pressure on the gas side of the high-pressure compressor 100, the head of piston 510 is pushed back a little to its initial position, depending on the prevailing pressure, and the escaping water is collected in tank 514.

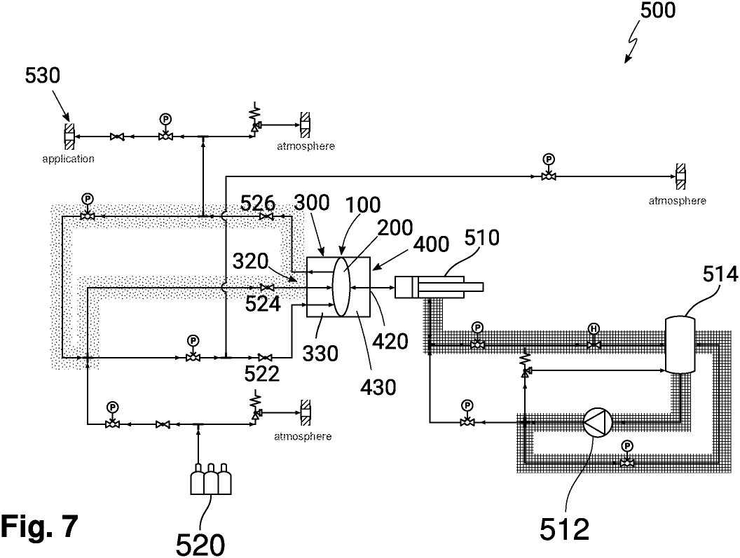

### Depressurizing the High-Pressure Compressor 100 (Fig. 7)

The relief line to tank 514 remains open and pump 512 continues to pump back into tank 514. The valve 524 for pressure relief on the gas side is opened and the pressure can be reduced quite quickly due to the small volumes respectively the diaphragm 200 can be deflected further towards the water side.

Then, the valve 522 can be opened again and the valve 524 for pressure relief can be closed to perform a new gas supply into the compressor chamber 330 of the cylinder head 300 and a high pressure compression.

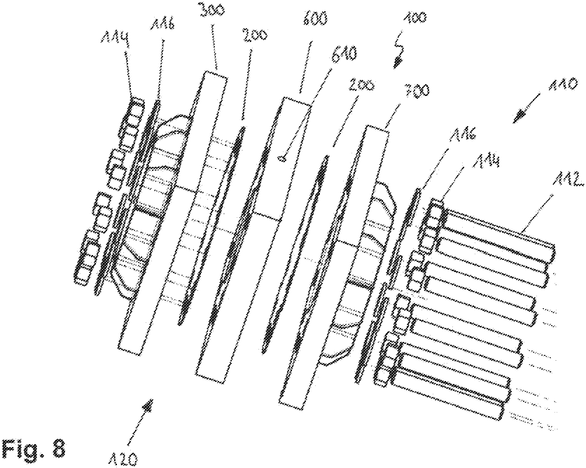

FIG. 8 shows an exploded view of a high-pressure compressor 100 of a second embodiment. The high-pressure compressor 100 of the second embodiment differs from the high-pressure compressor 100 shown in FIG. 1 in that the high-pressure compressor 100 has an intermediate plate 600, a third compressor head 700 and additionally a second diaphragm 200 instead of a second compressor head 400.

The third compressor head 700 has an identical design as the first compressor head 300. Instead of a media chamber 430 like the second compressor head 400, the third compressor head 700 has a second compressor chamber 730 into which a gas or gas mixture can be supplied and discharged via a third connection 720. The third connection 720 may be configured in the same manner as the second connection 320. Gas/gas mixture is supplied into the high-pressure compressor 100 of the second embodiment via the second connection 320 and the third connection 720 together.

The second diaphragm 200 and the first diaphragm 200 are identically formed, the first diaphragm 200 being arranged between the first compressor head 300 and the intermediate plate 600 and the second diaphragm 200 being arranged between the intermediate plate 600 and the third compressor head 700. The individual components of the housing 120 are held and braced relative to one another by fastening means 110, analogously to the first embodiment. Thereby, the diaphragms 200 come into flat contact with the surfaces of the first compressor head 300, the intermediate plate 600 and the third compressor head 700, which surround the compressor chambers 330, 730 and the media chamber 620.

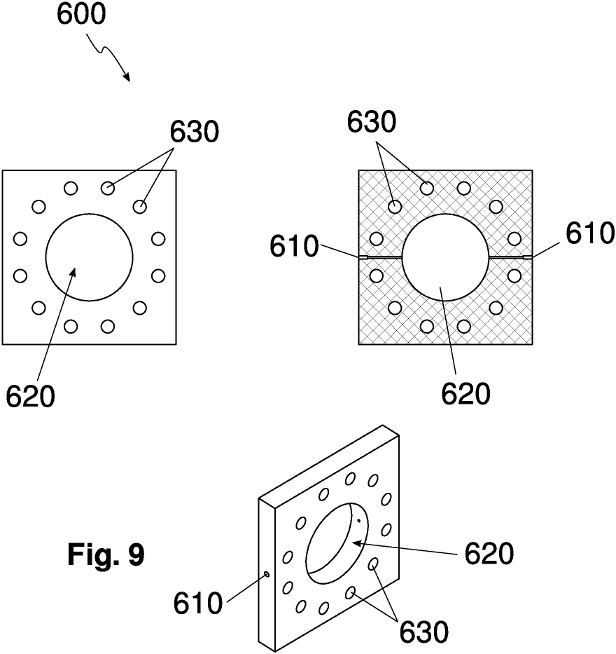

As shown in various views in FIG. 9, the intermediate plate 600 has a cylindrical, disk-shaped media chamber 620 into which an incompressible medium, e.g. water or (hydraulic) oil, can be supplied and discharged via two opposing third connections 610. By means of an appropriate control and valves, the supply and discharge of the incompressible medium can also take place via the two third connections 610 in such a way that one of the two third connections 610 serves only to supply media and the other third connections 610 serves only to discharge media.

The intermediate plate 600 also has openings 630 through which threaded rods 112 can be passed to connect the compressor heads 300, 700, the intermediate plate 600, and the diaphragms 200.

The intermediate plate 600 is made of the same material as the compressor heads 300, 400 and 700.

In this case, the diaphragms 200 can be deformed via introduced medium to such an extent that the diaphragms 200 come completely into contact with the inner sides of the compressor chambers 330, 730 in order to compress gas/gas mixture introduced into the compressor chambers 330, 730. For this purpose, a medium is introduced into the media chamber 620. For venting the compressor chambers 330, 730 and/or when gas/gas mixture is supplied into the compressor chambers 330, 730, the diaphragms 200 can be displaced to such an extent that they are immersed in the media chamber 620 and abut against each other. Thus, the entire available interior space of the housing 120 is available for high pressure compression, and high compression can be achieved in a manner analogous to the first embodiment described in FIG. 1. The high-pressure compressor 100 of the second embodiment thereby has substantially twice the volume for compression as the high-pressure compressor 100 of the first embodiment.

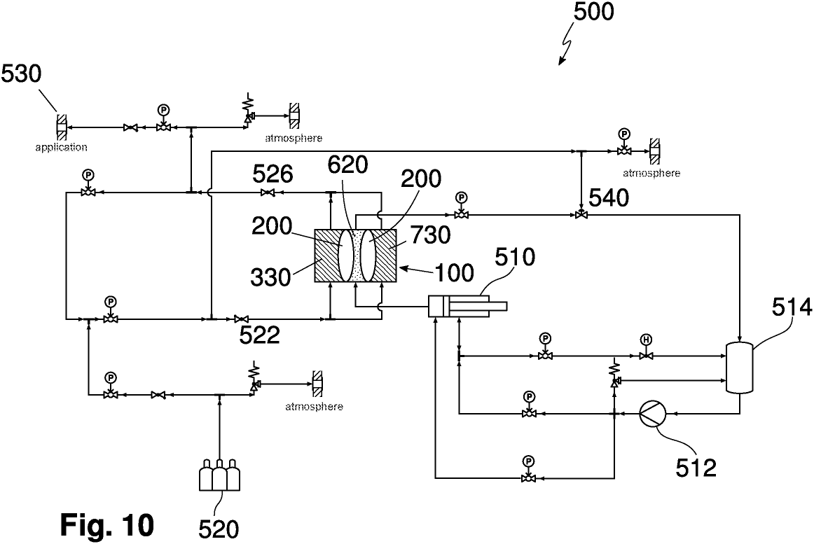

FIG. 10 shows a schematic representation of a compressor system 500 comprising a high-pressure compressor 100 of the second embodiment shown in FIG. 8.

In contrast to the compressor system 500 of FIGS. 3 to 7, the gas is supplied via valve 522 to the two compressor chambers 330, 730 together. The gas is supplied via the connection 320, 720. The compressed gas is discharged via further connections which are in communication with the compressor chambers 330, 730 and are configured, for example, in accordance with the connections 320, 720. In the process, the compressed gas is also discharged together.

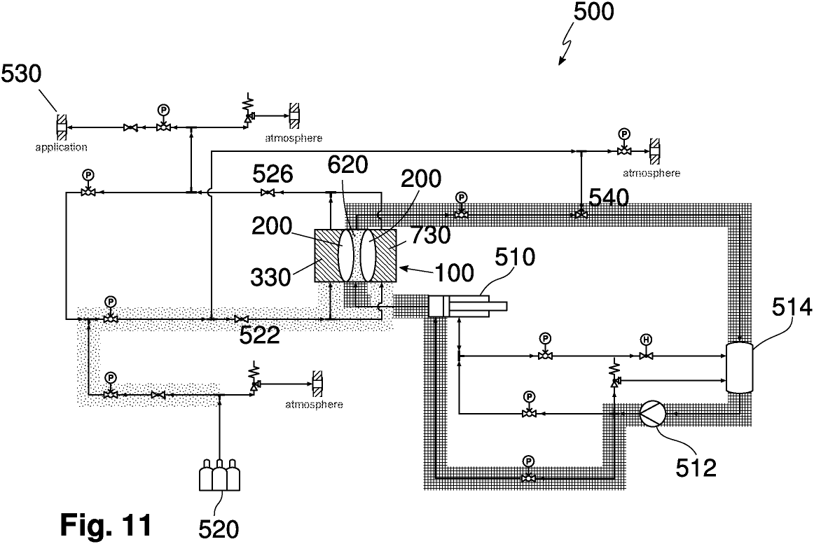

FIGS. 11-14 show various steps of high pressure compression in the compressor system of FIG. 10, with the compression steps corresponding to those of the compressor system 500 of FIGS. 3 to 7.

### Filling the High-Pressure Compressor 100 (Fig. 11)

The gas side or compressor chambers 330, 730 of the compressor heads 300, 700 of the high-pressure compressor 100 are filled with gas from the supply 520. For this purpose, the valve from the supply 520 and the valve 522 are opened so that gas is supplied to the compressor chambers 330, 730 via the second connection 320 and the fourth connection 720. Gas with a pressure of at least 10 bar is stored in the supply 520.

By introducing gas into the compressor chambers 330, 730, the diaphragms 200 are deflected towards the water side, i.e. towards the media chamber 620, and the pump 512 in the media circuit pumps the medium (e.g. water or oil) through the cylinder of the piston 510 and through the media chamber 620, with the pressure being coupled to the gas side in the gas circuit via a dome valve 540. Thus, in this condition, the diaphragms 200 are differential pressureless and thus do not deflect to either side. The constant flow through the front part of the cylinder of the piston 510 provides a constant heat exchange of the water, thus a temperature influence on a hydraulic medium for actuating the cylinder of the piston 510 can be neglected.

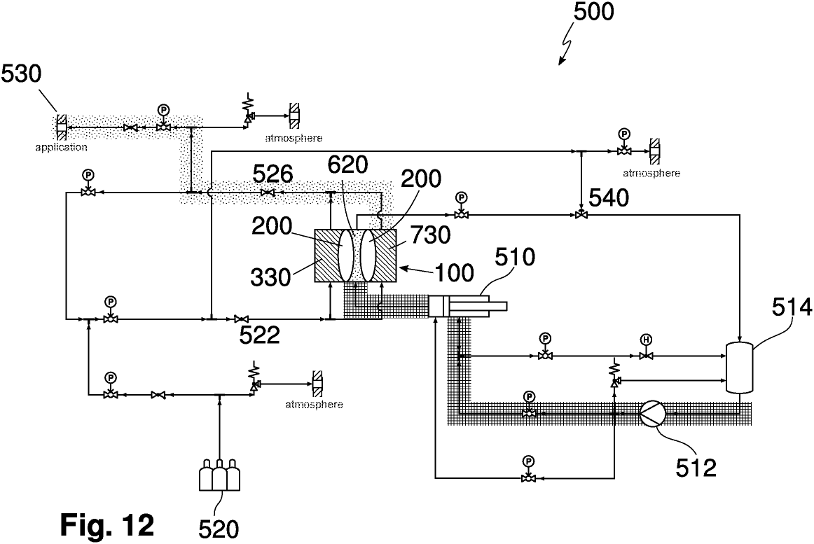

### Stroke Into the Application (Fig. 12)

The inlet valve 522 of the gas side is closed and the valve 526 to the application 530 is opened. In parallel, in the media circuit, the circuit through the forward side of the cylinder of the piston 510 is closed and the water is forced into the rear side of the cylinder, causing more volume to be delivered into the media chamber 620 via the water side of the high-pressure compressor 100. This change in volume provides compression of the gas on the gas side, resulting in an increase in pressure in the application 530.

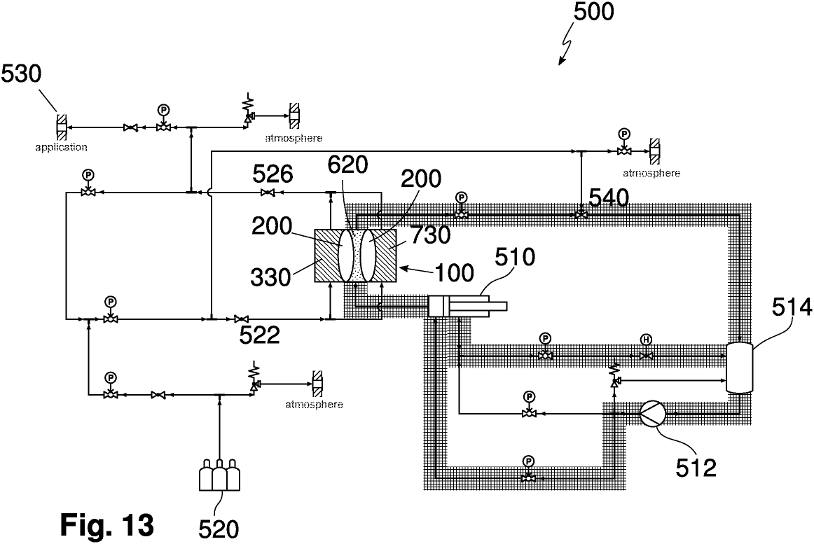

### Depressurizing the High-Pressure Compressor 100 (Fig. 13)

The valve 526 for gas application 530 is closed. The water circuit in the media circuit through the front part of the cylinder is opened and, in parallel, a relief line is opened into the tank 514. The pressure applied via the dome valve 540 in the front part of the cylinder forces the head of the piston 510 back to its initial position and the escaping water is collected in the tank 514.

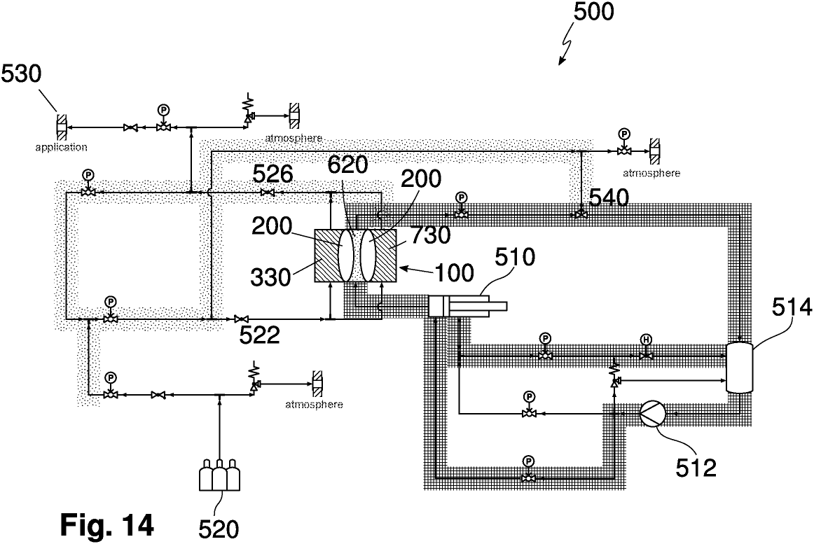

### Depressurizing the High-Pressure Compressor 100 (Fig. 14)

Water continues to flow through the front part of the cylinder and the relief line to tank 514 also remains open. A valve 524 for pressure relief on the gas side is opened and the pressure can be reduced quite quickly due to the small volumes.

For another high pressure compression of gas, the gas supply from the supply 520 is opened and the valve 524 is closed for pressure relief. Likewise, the relief line from the cylinder of the piston 510 is closed.

The processes for high pressure compression in the compressor systems 500 therefore differ only insignificantly.

FIG. 15 shows schematic representations of example embodiments of a first diaphragm 200 and/or a second diaphragm 200 for a high-pressure compressor 100 of the first embodiment and the second embodiment.

In various embodiments, the first diaphragm 200 and the second diaphragm 200 may be configured, for example, as shown in FIG. 15.

In a first embodiment, the first diaphragm 200 and the second diaphragm 200 are disc-shaped. The diameter of the diaphragms 200 is larger than the diameter of the compressor chambers 330, 730 and the media chambers 430, 620, so that the diaphragms 200 come into flat contact with the contact surfaces of the compressor heads 300, 400, 700 and the intermediate plate 600, depending on the embodiment.

Connecting elements, threaded rods 112 in the embodiments shown, are passed through the openings 220 of the diaphragms 200. The diaphragms 200 are made of a polymer-based material and therefore have “rubber-like” properties. The properties can be significantly adjusted depending on the application by appropriate selection of the polymers used, the thickness of the diaphragms 200 and other additives. The “rubber-like” properties allow the diaphragms 200 to be displaced to such an extent that they come into complete contact with the inner walls of the compressor chambers 330, 730 and the media chambers 430, 620. Moreover, this property allows additional sealing of the interior of the high-pressure compressor 100. The contact surfaces of the corresponding components (compressor heads 300, 400, 700, intermediate plate 600) can additionally have receiving recesses for the diaphragms 200 so that, away from the diaphragms, these components are in direct contact with each other.

Because of the essentially differential pressureless compression, i.e., the pressure from both sides on the diaphragms 200 is always the same during compression, simple polymer diaphragms can be used and no damage to the diaphragms 200 occurs.

The bottom representation of FIG. 15 shows both a diaphragm 200 that has a rectangular shape and a diaphragm that has a circular shape. The shape of the diaphragm 200 is not limited to the embodiments shown. Other shapes include polygonal designs (e.g., hexagonal, octagonal, tenth, twelfth, etc., or corresponding odd polygons). Essential to the teachings described herein, the diaphragm 200 overhangs the openings in the compressor heads 300, 400, 700 and the intermediate plate 600 in the region of the compressor chambers 330, 730 and the media chambers 430, 620 over a determinable minimum section, and this region is within the mounting sections (openings 220) in the embodiments shown.

In a first embodiment of the compressor system and a second embodiment of the compressor system, the valve 522 and the valve 524 and the valve 526 may be check valves.

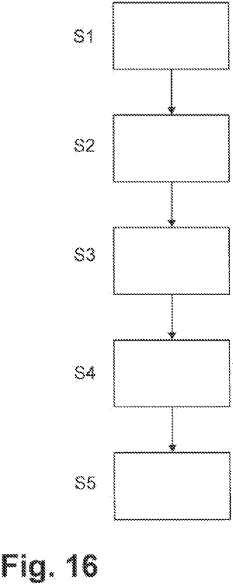

FIG. 16 shows a schematic diagram of high pressure compression in a compressor system 500 comprising a high-pressure compressor 100. Such a high-pressure compressor 100 may be, for example, a high-pressure compressor 100 of the first embodiment (FIG. 1) or a high-pressure compressor 100 of the second embodiment (FIG. 8).

In S1, the high-pressure compressor 100 is filled from the supply 520 (see FIG. 4/FIG. 11). For this purpose, the corresponding valves are opened or closed.

In S2, the stroke into application 530 (see FIG. 5/FIG. 12) from the high-pressure compressor 100 occurs.

In S3, a first intermediate step is performed to depressurize the high-pressure compressor 100 (see FIG. 6/FIG. 13), closing the supply of gas from the high-pressure compressor 100 to the gas application 530.

In S4, a second intermediate step is performed to depressurize the high-pressure compressor 100 (see FIG. 7/FIG. 14), wherein depressurization on the gas side is performed by opening the valve 524 and depressurizing.

In S5, a switchover for a new filling of the high-pressure compressor 100 takes place, for which the valve 522 is opened again and the valve 524 is closed for pressure relief.

The above procedure can always be repeated to achieve continuous high pressure compression for various applications.

Advantageously, the entire internal space within the housing 120 of the high-pressure compressor 100 is used for compression. Further, only the first diaphragm 200 and second diaphragm 200 are moved or deformed within the housing 120 so that, firstly, the space required for compression does not depend on the compression process via moving components and, further, substantially complete sealing of the compression space from the environment is achieved.

### List of Reference Signs

100 high-pressure compressor
110 fastening means
112 threaded rod
114 nut
116 washer
120 housing
200 diaphragm
210 bead
220 opening
300 compressor head
310 plate
312 wall
314 opening
320 second connection
330 compressor chamber
332 step
400 compressor head
410 plate
412 wall
414 opening
420 first connection
430 media chamber
432 step
500 compressor system
510 piston
512 pump
514 tank
520 supply
522 valve
524 valve
526 valve
530 application
540 dome valve
600 intermediate plate
610 third connection
620 media chamber
630 opening
700 compressor head
710 plate
712 wall
714 opening
720 fourth connection
730 second compressor chamber

1-9. (canceled)

10. A high-pressure compressor for compressing a gas or gas mixture, comprising:
at least one first compressor chamber;
a media chamber;
a housing, the housing surrounding the at least one first compressor chamber and the media chamber;
wherein the at least one first compressor chamber and the media chamber are separated from one another by at least one first diaphragm;
wherein the housing comprises at least one first connection which opens into the media chamber and via which a medium can be introduced into or discharged from the media chamber;
wherein the housing comprises at least one second connection which opens into the at least one first compressor chamber and via which a gas or gas mixture can be introduced or discharged; and
wherein the at least one first diaphragm comprises a polymer-based material and is deformable for compressing the gas or gas mixture that can be introduced into the at least one first compressor chamber by introducing a medium into the media chamber.

11. The high-pressure compressor of claim 10, wherein the at least one first compressor chamber and the media chamber have equal volumes.

12. The high-pressure compressor of claim 10, wherein the at least one first compressor chamber or the media chamber is in a shape of a spherical segment and the at least one first diaphragm forms the base of the spherical segment.

13. The high-pressure compressor of claim 10, wherein the at least one first diaphragm is deformable from an initial position to a second position where it comes into contact with an inner wall of the at least one first compressor chamber or the media chamber.

14. The high-pressure compressor of claim 10, further comprising a second compressor chamber separated from the media chamber by a second diaphragm, wherein the media chamber is arranged between the first compressor chamber and the second compressor chamber, and wherein the housing comprises at least one fourth connection which opens into the second compressor chamber and via which a gas or gas mixture can be introduced or discharged.

15. The high-pressure compressor of claim 14, wherein the housing is of layered construction and comprises a first compressor head with the first compressor chamber and a second compressor head with the media chamber, wherein the first diaphragm is arranged between the first compressor head and the second compressor head.

16. The high-pressure compressor of claim 14, wherein the housing is of layered construction and comprises a first compressor head with the first compressor chamber, an intermediate plate with the media chamber, and a third compressor head with the second compressor chamber, wherein the first diaphragm is arranged between the first compressor head and the intermediate plate and the second diaphragm is arranged between the intermediate plate and the third compressor head.

17. The high-pressure compressor of claim 14, wherein the at least one first diaphragm or the second diaphragm have a greater arial extent than a maximum diameter of the at least one first compressor chamber, the media chamber and the second compressor chamber.

18. The high-pressure compressor of claim 10, wherein the at least one first diaphragm is made of an elastomer and the elastomer includes ethylene propylene diene monomer (EPDM) or fluorocarbon rubber (FKM).

19. A compressor system for high pressure compression of a gas or gas mixture, comprising:
at least one high-pressure compressor according to claim 10;
a gas or gas mixture supply;
a gas or gas mixture storage;
a media supply;
conveying means for conveying a gas or gas mixture and an incompressible medium; and
control means for controlling a flow of the gas or gas mixture and the incompressible medium via associated lines.

20. The compressor system of claim 19, wherein the high-pressure compressor comprises wherein the first connection is connected to the media supply via one or more lines so that an incompressible medium can be introduced from the media supply via the first connection into the media chamber and from the media chamber into the media supply.

21. The compressor system of claim 19, wherein the at least one second connection is connected to the gas or gas mixture supply and the gas or gas mixture storage via one or more lines so that a gas or gas mixture can be introduced from the gas or gas mixture supply into the first compressor chamber and from the first compressor chamber into the gas or gas mixture storage.

22. The compressor system of claim 19, wherein the incompressible medium can be pressurized so that a deformation of the at least one first diaphragm achieves compression of the gas or gas mixture received in the at least one first compressor chamber such that one or more of the one or more lines to and from the gas or gas mixture supply, the gas or gas mixture storage, and the media supply can be closed off.
